(19) United States
(12) Patent Application Publication
(10) Pub. No.: US 2002/0085497 A1
(43) Pub. Date: Jul. 4, 2002

(54) Non-volatile data storage to cell-based switch fabric interface

(76) Inventors: Robert C. Phillips, Northbrook, IL (US); Mark D. Loffredo, Green Oaks, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/750,585

(22) Filed: Dec. 28, 2000

(51) Int. Cl. H04L 12/54

(52) U.S. Cl. 370/235.1; 370/429

(57) ABSTRACT

A non-volatile data storage interface unit and method for receiving/transmitting data via the interface unit are disclosed. The non-volatile data storage interface unit is generally incorporated into an information distribution system that is arranged to distribute information assets stored upon a non-volatile data storage such as movies or songs digitally stored upon a hard drive. The distribution system is also generally arranged to transmit the information assets on demand to users via a dynamic data transmission path. Therefore, once selected, the path (i.e., connection) transmits the information asset as a set of cells over a cell-based switching fabric.

The non-volatile data storage interface unit includes a cell transceiver that is connectable to the cell-based switching fabric. The cell transceiver includes a raw data to cell data formatting circuit that converts retrieved raw data into cell format suitable for transmission over the cell-based switching fabric. The cell transceiver also includes a cell data to raw data formatting circuit. The non-volatile data storage interface also includes a non-volatile data storage controller interposed between the cell transceiver and the non-volatile data storage. The non-volatile data storage controller and cell transceiver together perform functions previously rendered by a centralized programmed processor. A data buffer smoothes data transmissions to/from a non-volatile memory drive.

### CROSS-REFERENCE TO RELATED APPLICATION

This application is related to co-pending application by Phillips et al. U.S. application Ser. No. 09/579,574 filed on May 26, 2000, entitled “Information Distribution System and Method” that is explicitly incorporated herein by reference in its entirety, including any appendices and references therein.

### FIELD OF THE INVENTION

The present invention generally relates to the field of data server systems for handling requests from multiple users in a network environment. More particularly, the present invention concerns apparatuses and methods for providing data from hard disks or other high capacity non-volatile memory to a set of remote users via a cell-based (e.g., asynchronous transfer mode, referred to hereinafter as “ATM”) switch fabric.

### BACKGROUND OF THE INVENTION

There is a historic need to distribute electronically stored information assets to a large number of networked users simultaneously, in parallel, and on demand. The widespread growth of the Internet, cable, and satellite networks has resulted in a substantially heightened demand for information asset distribution services. A goal for system architects assigned the task of designing server systems is to provide systems with sufficient bandwidth to handle expected user request load without substantial degradation of service.

The type of information assets provided over digital networks varies greatly. Examples of such assets include text files, programs, static text pages, graphics, digitally encoded audio, digitally encoded video, etc. A particular area of interest is the relatively continuous delivery of digitally encoded audio and/or visual data over an extended period of time. This information asset transfer technique has been referred to as “streaming” data.

Traditionally, electronically stored information is utilized by individuals by obtaining a copy of the information stored on a portable non-volatile data storage medium such as an audiotape, videotape, floppy disk, CD ROM, etc. The user then views and/or listens to the information retrieved from the fixed portable memory via a dedicated non-volatile memory reader. The dedicated non-volatile memory readers include, by way of example, tape players, VCRs, CD players, DVD players, etc.

With the vast improvements present in today's communication infrastructure, obtaining information assets of the type described above would appear to be an inefficient distribution mechanism. There is no need to deal with the inconvenience of going to a retail outlet to purchase or rent a movie or album or other electronic information content when the same information asset can be downloaded via an electronic communication network. Properly implemented electronic distribution of such assets to authorized users should be far more efficient, convenient, and economical.

In fact, in certain situations physical distribution of information assets via portable non-volatile data storage media is undesirable and/or highly impractical. For example, in-room movies at hotels are a source of additional income for hotel owners and an expected amenity for tired hotel guests in search of a convenient entertainment alternative to cable television programming. Rather than provide each room with a separate videocassette recorder/player and managing physical distributing videocassettes, many hotels include a local network whereby a bank of video players continuously play a set of videotapes or other video storage media and guests simultaneously view an identical video feed originating from a single one of the video players.

Such known systems are not true “on demand” systems because users view or listen to a particular selection at the point of play where they joined rather than from start to finish regardless of when they joined. Additional start times may be accommodated by addition of players with staggered start times. However, such systems are costly due to the need to supply multiple players—one per staggered start. Such complete replication of entire devices greatly reduces the incentive of providers to supply a large number of staggered start times for a same information asset.

Today, with the proliferation of CD, DVD ROMs, and high capacity hard drives, movies are now being delivered via digitally encoded data streams to remote players. An example of such a system is disclosed in U.S. Pat. No. 5,973,722 to Wakai et al. entitled “Combined Digital Audio/Video On Demand and Broadcast Distribution System.” A set of media servers, each including a dedicated central processing unit, interface hard disk drives to an ATM switch. There is no description of how data passes from the hard disk drives to the ATM switch. In view of the inclusion of a Pentium processor 300 running Microsoft Corporation's WINDOWS Media Player in the more detailed depiction of the media player in FIG. 3 of Wakai et al., it is understood that the data is transferred in a conventional format. More specifically, the data is retrieved by the processor 300, converted to an ATM format, and then forwarded from the processor 300 to the ATM network adaptor 308.

The above described known systems appear to provide solutions to the basic need to provide distinct digital data feeds. However, it is unlikely that such systems would be expanded to supply dedicated feeds to individual users due to the high cost of replicating the media servers to perform such a task coupled with the limited throughput offered by the design of individual media servers. Therefore, it is unlikely that the distribution system of Wakai et al. would be offered to a large population of distinct users. However, there is a network connected market waiting for such a system—especially those living in remote destinations where retail outlets are not conveniently located to enable a customer to pick up a videotape, DVD, or CD.

### SUMMARY OF THE INVENTION

The present invention comprises a non-volatile data storage interface unit. The non-volatile data storage interface unit is generally incorporated into an information distribution system that is arranged to distribute information assets stored upon a non-volatile data storage such as movies or songs digitally stored upon a hard drive. The distribution system is also generally arranged to transmit the information assets on demand to users via a dynamic data transmission path. In other words, the path is not a dedicated path. However, once selected, the path (i.e., connection) transmits the information asset as a set of cells over a cell-based switching fabric.

The non-volatile data storage interface unit includes a cell transceiver that is connectable to the cell-based switching fabric. The cell transceiver facilitates transferring data cells between the non-volatile data storage interface unit and the cell-based switching fabric. More particularly the cell transceiver comprises a cell transmitter coupled to an output of the non-volatile data storage interface unit. The cell transmitter includes a raw data to cell data formatting circuit that converts retrieved raw data into cell format suitable for transmission over the cell-based switching fabric. The cell transceiver also includes a cell receiver that is coupled to an input of the non-volatile data storage interface unit. The input receives cells from the cell-based switching fabric containing both commands and data. The cell receiver includes a cell data to raw data formatting circuit. The cell data to raw data formatting circuit renders data suitable for storage on the non-volatile data storage.

The non-volatile data storage interface also includes a non-volatile data storage controller. The non-volatile data storage controller is interposed between the cell transceiver and the non-volatile data storage. The non-volatile data storage controller includes circuitry for retrieving and forwarding raw data from the non-volatile data storage to the cell transmitter. The data storage controller also includes circuitry for receiving and storing raw data from the cell receiver to the non-volatile data storage.

The non-volatile data storage controller and cell transceiver together perform functions previously rendered by a centralized programmed processor. Distributing the data processing functions, previously performed by a centralized programmed processor, to special purpose circuits/controllers in the non-volatile data storage controller eliminates the potential bottleneck of the centralized programmed processor and enhances the overall asset transmission throughput.

Furthermore, this arrangement facilitates direct communications between the set of non-volatile memory units (e.g., hard disks, CD ROMs, etc.) and the switch fabric that carries retrieved data to a set of network interfaces serving remote users. The data path from non-volatile memory drive to network interface includes a dedicated connection-based (e.g., ATM) interface to a switching fabric. The dedicated connection-based interface allows data to pass to an ATM switching fabric without passing first through a central processor. As a result, central processors are eliminated as a potential bottleneck in the transmission path between a non-volatile memory drive and a switching fabric.

In accordance with an embodiment of the present invention, a data buffer is provided to smooth data transmissions to and from a non-volatile memory drive. Thus, the memory drive is free to operate on multiple simultaneous requests by exploiting the very high burst rate of the memory drive as well as compensate for relatively long search latencies.

### BRIEF DESCRIPTION OF THE DRAWINGS

The appended claims set forth the features of the present invention with particularity. The invention, together with its objects and advantages, may be best understood from the following detailed description taken in conjunction with the accompanying drawings of which:

FIG. 1 is a schematic block diagram depicting primary components of an exemplary server system architecture incorporating the present invention;

FIG. 2 is an illustrative example of a cell-based switching fabric to hard disk interface depicting an embodiment of the present invention;

FIG. 3 is a schematic drawing depicting an exemplary embodiment of a cell receiver;

FIG. 4 is a schematic drawing depicting an exemplary embodiment of a cell transmitter;

FIG. 5 is a schematic drawing depicting an exemplary embodiment of a non-volatile memory controller in the form of a hard disk controller;

FIG. 6 is a schematic drawing depicting an exemplary embodiment of a RAM controller;

FIG. 7 is a flow chart depicting the stages for retrieving data from a hard disk, converting the raw data to a form suitable for transmission over a connection-based fabric, and then transmitting the data to the fabric;

FIG. 8 is a flow chart depicting the stages associated with writing data, with data buffering, to a hard disk in a system incorporating the present invention; and

FIG. 9 is a flow chart depicting a stages associated with writing data, without buffering, to a hard disk in a system incorporating the present invention.

### DETAILED DESCRIPTION OF AN ILLUSTRATIVE EMBODIMENT

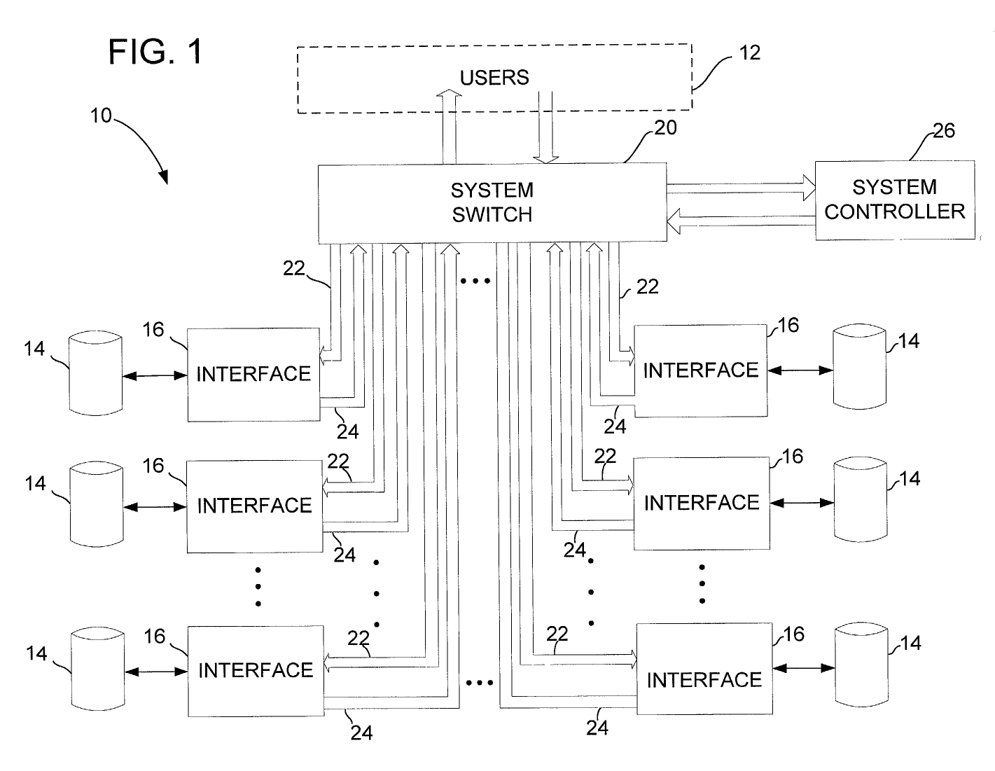

A new non-volatile memory drive to connection-based switch network interface is described below in the form of a preferred embodiment and variations thereof. The new interface includes a drive controller that is responsible for at least retrieving data from a non-volatile memory. A cell transmitter, coupled to the drive controller receives the retrieved raw data from the drive controller and converts the raw data into a form suitable for a connection-based switching fabric (also referred to herein as “fabric”). In a particular embodiment the switching fabric is a variation of well-known ATM switch fabrics. A description of the exemplary command and data cell formats is provided herein below in an appendix section of the specification following the description of the FIGS. 1-9.

An embodiment of the interface preferably, though not necessarily, includes a cell receiver and buffering dynamic RAM. The cell receiver is interposed between the connection-based switching fabric and the drive controller. The buffering RAM is coupled to the drive controller via a RAM controller. The buffering RAM handles the bursty nature of data transmissions to and from the drive controller.

Having generally described an embodiment of the invention and exemplary alternatives, attention is now directed to FIG. 1, a high level block diagram schematically depicting primary components in a server system that advantageously incorporates a drive-to-switching fabric interface embodying the present invention. The server system is described in detail in Phillips et al. U.S. application Ser. No. 09/579,574 filed on May 26, 2000, entitled “Information Distribution System and Method” the contents of which are incorporated herein in their entirety. FIG. 1 illustrates various basic components and the general arrangement of the architecture of an information distribution system 10 incorporating an embodiment of the present invention. The information distribution system 10 receives requests for the distribution of particular information assets from any number of various users 12. In response to the requests, the system locates the information assets and distributes the particular information assets to the requesting user(s).

According to an aspect of the present invention, the system may operate as an “information-on-demand” system where any of the information assets may be distributed to any of the users at any time, even in the case where the same information asset is distributed to a plurality of users simultaneously. It should be understood that, particularly in connection with this latter situation, distribution of a particular information asset to several users simultaneously may require distributing the asset at a particular distribution rate for each user. Further complexity is introduced when, as may typically be the case, the information asset is large in size and multiple users have requested the asset at different times, so distribution of the asset will be proceeding simultaneously but at different points within the asset. One useful example of such a situation is the simultaneous distribution of a plurality of video information assets. Video information assets may be extremely large files which are usually distributed in segments as the information is viewed (or partially buffered) by the user. This is a process that is more commonly known as “streaming” of video information. While some users may have some buffering capability, usually the system will be required to distribute video information in segments, such as blocks of a predetermined size requested by the user, until the entire video asset is distributed or the user issues an instruction to discontinue the distribution.

A great plurality of information assets, such as files containing video, audio, image, text or other data, is stored on a plurality of mass storage devices 14. According to one embodiment of the invention, the mass storage devices 14 may be hard disk drives. Associated with each mass storage device 14 is a mass storage device interface 16 that issues appropriate instructions to the mass storage device 14 to retrieve the information desired. Interface 16 comprises the general subject matter of the present invention.

The interface unit 16 of each of the mass storage devices 14 is communicatively connected to a system switch 20 to allow transmission of data and information between the switch 20 and the interface 16. The system switch 20 is also communicatively connected to the users 12 of the system 10. Information and instructions transmitted between the system 10 and the users 12 are sent through the system switch 20. According to the illustrated embodiment of the invention, for each of the interface units 16, there is provided a first transmission line 22 for transmitting information from the switch 20 to the interface unit 16, and a second transmission line 24 for transmitting information from the interface unit 16 to the switch 20. Although it may be possible to implement an information-on-demand system in accordance with the present invention with only a single transmission line between the switch and each interface unit 16 that handles bidirectional transmissions, the illustrated architecture may be preferable because it will allow transmission of information to the users while simultaneously providing the interface unit 16 with additional instructions or information.

Another element of the fundamental architecture of the illustrated system incorporating the present invention is a system controller 26. The system controller 26 is generally responsible for receiving requests from users for information assets, organizing the requests and forwarding them through the switch 20 to appropriate interface units 16 which will retrieve the requested information from the associated mass storage device 14 and transmit the information through the switch 20 and directly to the user or a gateway associated with the user 12. The system controller 26 will also be responsible for various “bookkeeping” duties with the system 10. For example, the system controller 26 may maintain an up-to-date library of information assets available on the mass storage devices 14, may monitor usage statistics of various information assets, may move various information assets between different mass storage devices 14, and perform numerous other administrative functions.

Information which is distributed by the system 10 may be transmitted directly through the switch 20 to the users. In contrast, conventional prior art information distribution systems have been commonly based upon a decades-old computer system architecture having three common bus elements—one for data, one for address information and one for control information. Since such conventional prior art systems have one common data bus, complicated bus contention protocols must be provided and, moreover, only one mass storage device can be placing information on the data bus at a time. Many other complications, inefficiencies and problems are encountered when attempting to utilize such a conventional architecture to perform an information distribution function. In this regard, the disclosed system provides a plurality of data transmission lines 22, 24, each of which may be independently and simultaneously transmitting information asset data to users. Such an architecture substantially increases the performance, flexibility and capacity of the system to simultaneously deliver multiple streams of information asset data to a plurality of users, i.e., to effectively operate as a genuine information-on-demand system.

Although the exemplary system is illustrated in FIG. 1 such that there is a single mass storage device 14 associated with each interface unit 16, according to an alternative embodiment, the system accommodates multiple mass storage devices 14 for a single interface unit 16. For example, the amount of information storage for the system may effectively be doubled by providing two disk drives for each disk interface unit. Such an implementation may be readily realized based upon the fundamental architecture illustrated in FIG. 1, particularly if an effective data transmission protocol is utilized, as will be described in greater detail below. Thus, when a request for information is received by a disk interface unit 16, the disk interface unit 16 examines the request to determine which of a plurality of disk drives 14 the request is directed to. In response, the disk interface unit 16 will direct the information request to the appropriate disk drive 14 associated with the disk interface unit 16, receive the requested information from the disk drive 14, and transmit the information through the switch 20 to the requesting source which, in most cases, will be a user.

As will be readily apparent to one of skill in the art, the exemplary system illustratively depicted in FIG. 1 represents a substantial improvement over conventional systems because, among other things, it is not limited to the traditional bus-based architecture. Further efficiencies and advantages of the present invention may be realized by utilizing particularly effective data transmission protocols. A messaging or cell-based protocol for transmission of data and information between various elements of the system is utilized. In this regard, instructions and information are transmitted through the system in units such as a cell, message or packet that typically will contain, in addition to the data or information, a header used to identify the source as well as the destination for the unit of information. Using such a protocol, a request for an information asset from a user may initially be directed through the switch 20 to the system controller 26, which will determine if the information asset is available and where it resides on the system. Once the system controller 26 determines that the particular information asset exists on the system 10, the system controller 26 may, as appropriate, generate one or more requests to the appropriate interface unit 16.

The requests for an information asset from a user may be handled on a session basis. For example, when an initial request from a user for a new information asset is received by the system controller 26, the system controller 26 may establish a new session, and generate a unique handle to identify the session. When a new session is established, virtual circuits within the system switch 20 may be set up to handle communications for the new session. For example, the system switch 20 may, based upon the circuit identifier, route information for a particular session from the appropriate interface unit 16 to the requesting user 12 via the virtual circuit set up when the session was established. The system controller 26 may set up multiple virtual circuits between the same end points, but each traversing a different path through the system switch 26. When doing so the circuits will be configured so that information assets arrive at the destination as though it was a single circuit. The system controller 26 may select which circuit to use on a packet by packet basis, ensuring that at most one of the circuits is actually in use for any specific packet. In a similar manner, a virtual circuit within the system switch 20 may be set up to handle communications from the system controller 26 to the interface unit 16 associated with the mass storage device 14 that contains the information asset requested. Typically, these virtual circuits will remain in place for the entire session. However, it is possible that the routing of the virtual circuit, or simply the selection amongst the already provisioned circuits, may be changed in the case of certain events within the system. According to one embodiment, the set of virtual circuits that may be used for a given session will have a collective identifier, or handle. For example, in the event that a mass storage device 14 which is supplying a requested information asset experiences a technical problem, such a fault may be communicated to or sensed by the system controller 26 which, in response, may establish or select a different virtual circuit under the same handle which will allow the same information asset on a different mass storage device 14 to be transmitted to the user through the switch. As may be appreciated, this same approach may be used in the case of other events that might compel the changing of which of the mass storage device 14 that contain a particular information asset are used to deliver that asset to a user. Because of the unique design of the system, such a change in the supplying mass storage device 14 will be transparent to the requesting user.

In general, the illustratively depicted system incorporating an interface 16 embodying the present invention may be advantageously implemented with a self-routing switching technique, also sometimes referred to as a self-routing “switching fabric”. The term “switching fabric” means, for example, the combination of hardware and software that moves data coming into the system switch out to the correct port or communication channel, which in turn may provide the data to another network. With a self-routing switching fabric, the path a packet or cell takes through the fabric is determined by a circuit identifier in the packet or cell header. The originating port alone is insufficient to determine the routing of the cell or packet.

Further characteristics of a self-routing switching fabric are that all packets or cells sent with the same circuit identifier at a given port will arrive at the same target port. All cells that arrive will arrive in the same order, and cells may be dropped, but not re-ordered. All of these cells will have the same circuit identifier. This may be changed during transit through the fabric, but any such changes will apply to all cells that successfully transit the system. In some cases, this path is referred to as a “virtual circuit”. Typically, the circuit must be set up prior to the first cell or packet being transmitted.

Such a self-routing switching fabric differs from setting up an actual circuit, where all packets or cells from a given port will always be delivered to the same destination without need for headers. However, such an actual circuit arrangement would not support use of a single port to interleave output for many destinations over a short period of time.

A self-routing switching fabric also differs from techniques such as Internet Protocol (IP) routing where there is no pre-determined route for each packet. Under such a protocol, the packets are labeled with the desired destination, rather than by the circuit they should follow. At each step, or hop, over the fabric, the router merely makes its best effort to send the packet closer to the packet's final destination. Different packets may take different paths, and hence could arrive out of order. While this form of routing may be preferable for sporadic messages of short duration, it is far less efficient for large transfers and is typically especially inefficient for long streaming operations.

According to an embodiment of the system 10, the ATM (asynchronous transfer mode) dedicated-connection switching protocol may be used to transmit information between various components of the system. Other switching technologies may be applicable. The preferred selection of ATM reflects primarily the cost tradeoffs in the design rather than a necessity for a specific switching protocol. Of course, a standard disk drive interface may be used to handle communication between the disk interface unit and the disk drive or drives which are associated with the disk interface unit. According to the ATM protocol, 53-byte cells may be transmitted between various components of the system. As will be explained in greater detail in the following examples, the particular characteristics of the ATM protocol make it very effective for information-on-demand performance, especially when implemented in connection with the unique system architecture of the present invention.

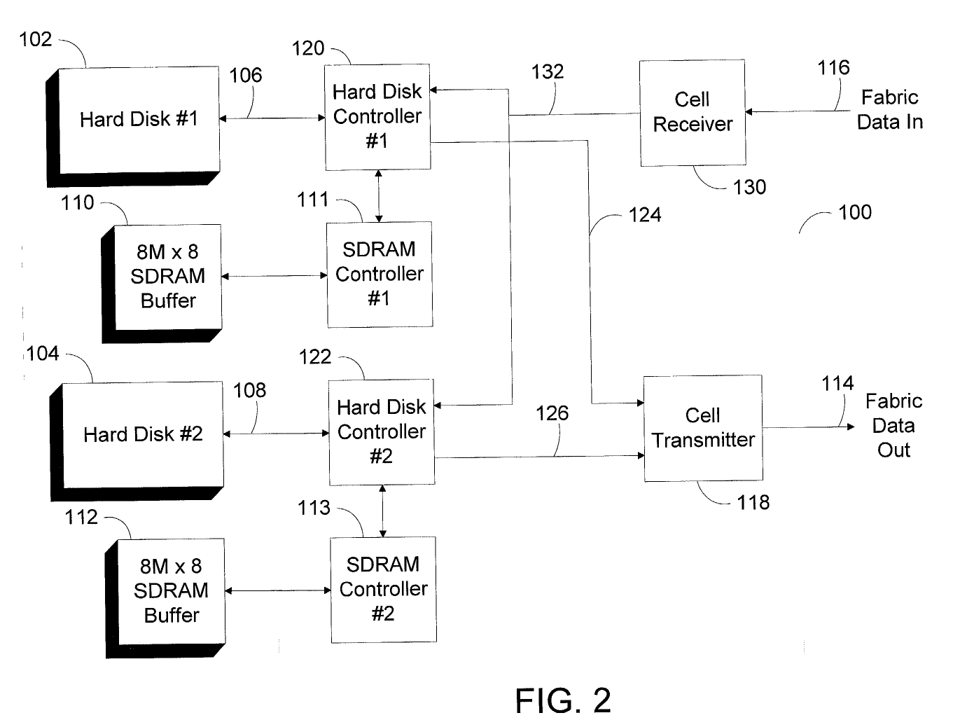

Having generally described a system 10 for incorporating a non-volatile memory drive to switching fabric interface embodying the present invention, attention is now directed to FIG. 2. Turning to FIG. 2, a schematic diagram depicts the primary components of a hard disk to switch fabric interface 100 embodying the present invention. In the illustrative embodiment, the interface 100, generally corresponding to the interface 16 of FIG. 1, supports two hard disks 102 and 104. However, as those skilled in the art will readily appreciate, the number of non-volatile drives (e.g., hard disks) supported by each instance of the interface 100 may be reduced or increased without deviating from the present invention.

Turning first to the non-volatile memory drive connections, the interface 100 transmits raw data to, and receives raw data from, hard disks 102 and 104 via drive buses 106 and 108, respectively. The drive buses 106 and 108 are preferably constructed according to well known IDE bus interface standards. However, the arrangement of lines on drive buses 106 and 108 may be varied in accordance with various non-volatile memory interface standards and/or specifications as well as customized variations thereof. Such interface standards include, for example SCSI, Serial ATA, etc.

The preferred embodiment of the interface 100 buffers data transmissions to and from the hard disks 102 and 104. Random access memory (RAM) 110 and 112 associated with the hard disks 102 and 104, respectively, store the bursts of data that arrive from the hard disks 102 and 104 prior to being transmitted via the interface 100 to a switch fabric via fabric data out lines 114. Similarly, the RAM 110 and 112, under the control of RAM controllers 111 and 113 respectively, store bursts of data received from the switch fabric via fabric data in lines 116. The form of the data out lines 114 and data in lines 116 is arranged, in an embodiment of the present invention, in accordance with well-known ATM standards. However, alternative data line arrangements for interfacing to a connection-based (e.g., ATM) switch fabric are contemplated in accordance with alternative embodiments of the present invention embodying alternative protocols/standards and customized variations thereof. Other connection-based protocols/standards include Arcnet, etc.

Having described the external connections of the interface 100, attention is now directed to the internal circuits that make up the functional components of the interface 100. The depicted components enable the interface to transmit data directly to a connection-based switch fabric thereby by-passing communications with an expensive general purpose programmed central processor unit. The interface is also capable of converting data received in a form associated with transmissions on a connection-based switch fabric to a raw data format expected for storage on the hard disks 102 and 104.

The interface 100 includes a cell transmitter 118. The cell transmitter 118 receives raw data, and instructions for transmitting the raw data, from a hard disk controller 120 or hard disk controller 122. The hard disk controllers 120 and 122 transmit raw data within the interface 100 via lines 124 and 126 respectively to the cell transmitter 118. The cell transmitter 118 packages the received raw data in accordance with data transmission standards (e.g., ATM) and then transmits the data via data out lines 114. The cell transmitter 118 includes an internal multiplexer that selects one of the input lines 124 and 126 at any particular point in time. However, in an alternative embodiment a multiplexer outside the cell transmitter 118 performs the selection function.

The interface 100 also includes a cell receiver 130. The cell receiver 130 receives data and instructions for storing the data via data in lines 116. The data received via data in lines 116 is packaged in accordance with transmission protocols for a connection-based switch fabric (e.g., ATM). The cell receiver 130 decodes data cells received via data in lines 116 and selectively transmits the decoded data on lines 132 to the hard disk controllers 120 and 122. Though not specifically identified in FIG. 2, transmit control lines selectively activate the hard disk controllers 120 and 122 to receive data transmitted by the cell receiver 130 via lines 132.

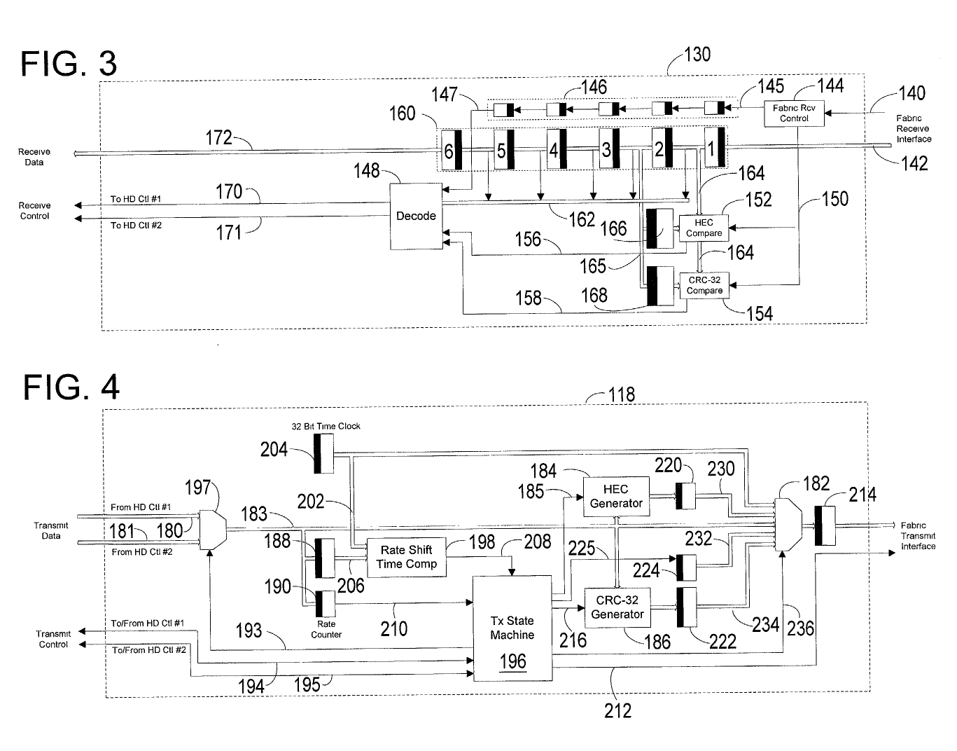

Having described the interface 100 at a high level, attention is now directed to FIGS. 3-6 that provide a more detailed view of interface circuitry comprising an exemplary embodiment of the present invention. A schematic diagram depicted in FIG. 3 comprises a set of components making up the cell receiver 130. Fabric data in lines 116 are depicted as separate control lines 140 and data lines 142. The data lines are 8-bit parallel, and the control lines, while depicted as a single line in FIG. 3 are, by way of example for an ATM interface, two separate lines carrying a clock control signal and frame control signal. In alternative embodiments of the invention no distinction is made between control and data lines, and a single set of lines carry both data and control information.

A fabric receive control circuit 144 receives and distributes control data received on control lines 140 to a set of sequentially coupled control data cells (via line 145) that are arranged as a 5-bit shift register 146. Contents of the 5-bit shift register 146 are serially transmitted via line 147 to a decode circuit 148. The control data received on lines 140 is also captured and manipulated to be forwarded via line 150 to control an HEC (Header Error Control) compare circuit 152 and CRC-32 (a known 32-bit cyclical redundancy check algorithm) compare circuit 154 that check for errors in data received via lines 142.

The fabric receive control circuit 144 determines, through the fabric receive interface lines 140, that a cell is being received and commences tracking (i.e., counting) the number of bytes of the cell received thereafter. Through the count, the fabric receive control circuit 144 determines and controls commencement and completion of HEC calculations and CRC-32 calculations on data received via lines 165 by an HEC accumulator 166 and a CRC-32 accumulator 168. The fabric receive control circuit 144 issues control signals at appropriate times via line 150 to cause the HEC compare circuit 152 and CRC-32 compare circuit 154 to compare the accumulated contents of the HEC accumulator 166 and CRC-32 accumulator 168 to actual values passed into the cell receiver from the fabric via lines 142. The actual values are transmitted to the HEC compare circuit 152 and CRC-32 compare circuit 154 via lines 164. The HEC compare circuit 152 and CRC-32 compare circuit 154 perform well-known data transmission accuracy checks to ensure the accuracy of data transmissions to the interface 100. The HEC compare circuit 152 and CRC-32 compare circuit 154 issue error control signals to the decode circuit 148 via lines 156 and 158 respectively.

The data lines 142 are connected to an input of a six-stage shift register 160. In the illustrative embodiment each register, and thus the data path through the shift register 160, is 8-bits. Selected bits from the output of stages 1 through 5 of the six-stage shift register 160 are transmitted via parallel lines 162 to the decoder 148. The output of the first stage of the register 160 is read directly by HEC compare circuit 152 and the CRC-32 compare circuit 154 via line 164. The output of the second stage of the register 160 is transmitted on line 165 to be accumulated in an HEC accumulator 166 and a CRC-32 accumulator 168 thereby facilitating execution of well known HEC and CRC algorithms. The results of the HEC and CRC analyses on the received data performed by the HEC compare circuit 152 and the CRC-32 compare circuit 154 are transmitted in the form of status signals on lines 156 and 158 to the decoder 148.

The decoder 148, preferably comprises a hardwired control circuit that acts upon the control, data, and error status signals received via lines 147, 162, 156 and 158 to issue appropriate control signals on line 170 or 171 to the hard disk controllers 120 and 122. Data is transmitted via bus 172 from the final (i.e., sixth) stage of the six-stage shift register 160. It is noted that while a parallel data transmission path is depicted for the bus 172, in alternative embodiments of the invention a serial data line transmits data between the cell receiver 130 and the hard disk controllers 120 and 122. The above-described cell receiver circuit is merely exemplary, and many alternative circuits for carrying out the invention, in accordance with potentially many different protocols, will be known to those skilled in the art. The following summarizes the operation of the cell receiver interface depicted in FIG. 3. The cell receiver interface of FIG. 3 receives data cells via data lines 142 and sequentially shifts the cells into the series-connected set of six registers 160 from which destination and control information is obtained. The shift process continues and header data is stored until destination and control information is captured. A count of received data, by the fabric receive control 144-facilitates determining the position of specific header data as well as the starting position of the payload. After capturing the header data, the data receive circuit of FIG. 3 forwards payload data that follows via lines 172 to a destination specified by the header.

Having described the cell receiver interface, attention is directed to FIG. 4 that illustratively depicts an exemplary cell transmitter interface. Transmit data is transmitted from the hard disk controllers 120 and 122 via data lines 180 and 181 respectively, to a multiplexer 197. The multiplexer 197 selectively routes data on lines 180 and 181 via data bus 183 to a multiplexer 182, an HEC generator 184, a CRC-32 generator 186, a rate shift time register 188, and a burst rate counter 190. A set of control lines 194 and 195 carry control signals between a transmission state machine 196 and the hard disk controllers 120 and 122 respectively.

A rate shift time comparator 198 performs the function of providing a rate select signal via line 208 to the transmission state machine 196. The rate shift time comparator 198 receives a clock input value via line 202 from a 32-bit relative time clock 204 and a rate shift value via line 206 from the rate shift time register 188. The rate shift time comparator 198 compares the value from the rate shift time register 188 to the value from the relative time clock 204. If the compared values indicate that the relative time is less than the rate shift time, then the burst rate counter 190 is loaded with a primary cell rate count. If the relative time exceeds the rate shift time, then the burst rate counter 190 is loaded with a secondary cell rate count. This feature adds flexibility to the transmitter by facilitating specifying different cell rates based on a specified timing (e.g., scheduling) requirement.

The rate shift time comparator 198 transmits the rate select signal on line 208 to the transmission state machine 196. The transmission state machine 196 then issues a request via control lines 194/195 to load the appropriate rate amount (primary or secondary) by way of the selected transmit data bus 180/181. The rate values are held in the message ram 278. The burst rate counter 190 issues a burst rate time out status/control signal via line 210 to the transmission state machine 196 to signal that the next cell can be sent (when the pre-loaded counter 190 has counted down to zero).

The transmission state machine 196 receives the aforementioned input status/control information and issues control signals to the multiplexer 182 (controlling the selection of an input to be passed to an output register 214). Additional output signals on line 216 control operation of the HEC generator 184 and CRC-32 generator 186 to load appropriate HEC and CRC-32 values into registers 220 and 222 respectively.

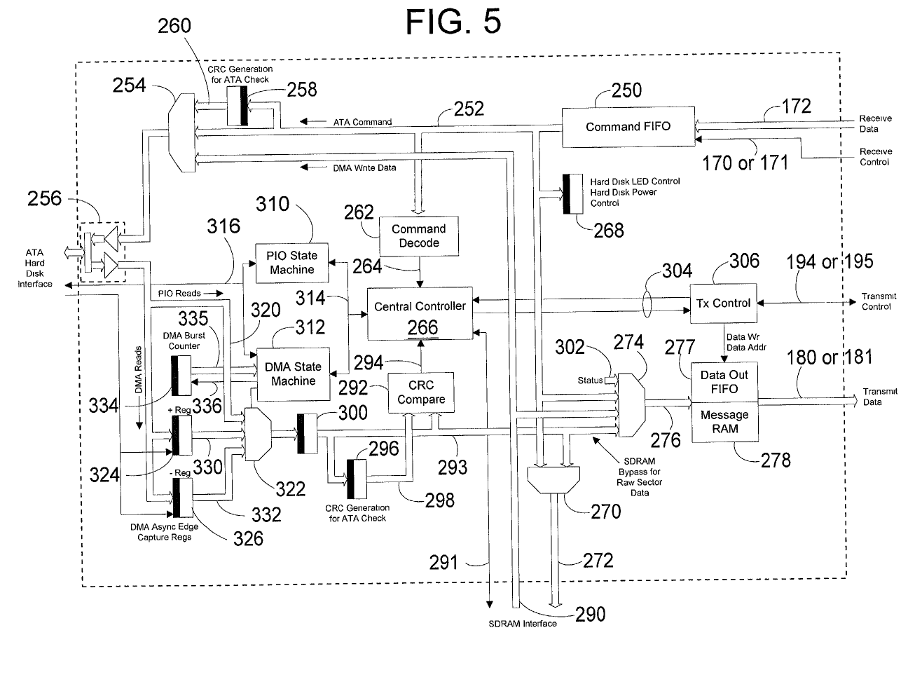

A data size count register 224 receives a count value from a control message RAM 278 (see, FIG. 5) via the transmit data lines 180/181. The data count value is transmitted in advance of an actual data message to inform the transmitter of a message (or message segment) size. As data is sent, the count register 224 is decremented via a control signal transmitted on line 225 for every byte sent. When the count reaches zero, the transmitter terminates the current packet transmission.

The multiplexer 182 receives a variety of message control information as well as content data from the aforementioned transmitter circuitry. In addition to data received via bus 183, a clock value representing the relative transmission rate is transmitted on line 202 to the multiplexer 182. An HEC value calculated by the HEC generator 184 is read from the HEC register 220 via lines 230. A data segment size count is read from the data size count register 224 via lines 232. A CRC value is read from the CRC-32 register 222 via lines 234. Selection of input by the multiplexer 182 to load register 214 is performed under the control of a selection value transmitted by the transmission state machine 196 to the multiplexer 182 via lines 236.

Various data is available to the (output) multiplexer 182 and cells are generated by selecting the particular data needed at the time of the specific time slice of transmission. In other words, cells are generated by selecting data “on the fly” as needed by the required cell format. The real-time data selection to generate cells is controlled by the transmission state machine 196.

By way of example, the following steps are performed by the cell transmitter of FIG. 4 to generate a data cell. The transmission state machine 196 generates a request for the destination header information stored in the message ram 278 (of FIG. 5) via the transmit control lines 194/195. The transmission state machine 196 selects the appropriate transmit data bus 180/181 from which data will be routed through multiplexer 197 according to a select signal on control line 193. The data from the selected transmit path (180/181) passes through multiplexer 197 to data bus 183. The data on bus 183 is selectively routed through the output multiplexer 182 by way of the multiplexer 197 according to signals transmitted on the multiplexer control lines 236.

Initially destination header information is transferred to the output register 214 one byte at a time. As the header information is transmitted over bus 183, the HEC generator observes the header bytes to render an HEC check byte that is stored in the HEC register 220. As soon as the four bytes of the destination header has been sent from the message ram 278 (of FIG. 5) to the output register 214, the transmission state machine 196 issues a new control value to the multiplexer 182 to select input lines 230 from the HEC register 220. This enables transmission of the value stored in the HEC register 220 to the output register 214.

While the HEC value is being transmitted from the output register 214, the transmission state machine 196 generates a request via transmit control lines 194/195 (depending on the selected hard disk) for payload data, corresponding to the header, stored in a data out FIFO 277 (see, FIG. 5). The transmission state machine 196 issues a signal on line 193 selecting one of the transmit data lines 180/181 via the multiplexer 197 to transmit data to the fabric transmit interface (not shown) by way of the bus 183, the (output) multiplexer 182, and the output register 214. The transmission state machine 196 routes data on the bus 183 through multiplexer 182 to the output register 214 by issuing an appropriate input select signal on lines 236 to the multiplexer. The payload data is transferred via bus 183 to the output register 214 one byte at a time.

The transmission state machine 196 keeps track of the number of bytes to be read from the data out FIFO 277 and makes a determination of when the end of the data for a cell is reached and terminates the cell with a CRC-32 value. During the transmission, CRC-32 generator observes the content of the payload data bytes to render a CRC-32 value for transmitted data. The CRC-32 value can represent the value for any of a number of different collections of transmitted bytes. For example, the CRC-32 value can be generated and transmitted for each payload data section in a cell, for an entire cell (including the header), a packet, a message, etc. When the end of a relevant transmission is reached, the accumulated CRC-32 value for the transmission is selectively transmitted, under the control of the transmission state machine 196 and select lines 236, via multiplexer 182 to the output register 214 (and the fabric transmit interface).

Turning now to FIG. 5, an exemplary set of circuits are illustratively depicted for a hard disk controller (e.g., hard disk controller 110 or 112) incorporated into the interface 100 embodying the present invention. In general, the hard disk controller is responsible for receiving and transmitting commands and raw data from a variety of sources and destinations including the cell transmitter 118, the cell receiver 130, a hard disk (e.g., hard disk 102) and a buffer RAM (e.g., buffer RAM 110). The hard disk controller converts high level request commands from the cell receiver 118 into low level, protocol-specific non-volatile memory media requests. The hard disk controller also directs data between a buffer RAM controller (e.g., controller 111) and either a hard disk, cell receiver, or cell transmitter.

With reference to FIG. 5, a command FIFO buffer 250 receives data and control signals from the cell receiver 130 via lines 172 and 170 (or 171) respectively. The output from the command FIFO is transmitted via receive data bus 252 to multiple circuits. While not specifically depicted in FIG. 5, each of the multiple circuits connected to receive data bus 252 is controlled via address/enable signals or via internal data bit pattern recognition circuitry to recognize and/or respond to particular portions of the stream of data transmitted by the command FIFO 250 on data bus 252.

Turning now to specific circuits connected to the data bus 252, a multiplexer 254 receives data on data bus 252 for purposes of directly transmitting ATA (Advanced Technology Attachment, an enhanced version of the disk drive interface standard commonly known as Integrated Drive Electronics, or IDE) commands to a hard disk via hard disk driver interface 256. The receive data bus 252 is also connected to a CRC generator 258 that determines the validity of data to be written to the ATA hard drive. The CRC generator 258 transmits CRC values via lines 260 to the multiplexer 254.

The data bus 252 also connects the output of the command FIFO 250 to a command decoder 262. The command decoder 262 detects and decodes commands within the stream of data transmitted on receive data bus 252. The command decoder 262 is, by way of example, a hardwired circuit that transforms detected received commands into command control signals. The command decoder 262 transmits the resulting command control signals on line 264 to the central controller circuit 266.

The receive data bus 252 provides a number of additional direct paths between the command FIFO 250 and control/data interface components of the hard disk controller. The receive data bus 252 is connected to a hard disk LED control and hard disk power control 268. The LED and power control 268 controls the state of operation of a hard disk LED (indicating use) as well as power to a motor causing a hard drive to spin. Receive data bus 252 is also connected to a dynamic RAM multiplexer 270 for purposes of transmitting raw sector data from the hard disk controller to the RAM 110 or 112 of FIG. 2 via data bus 272. Finally, the receive data bus 252 transfers data to a transmit data multiplexer 274. The output of multiplexer 274 is connected via line 276 to data output FIFO buffer and message RAM 278 via lines 280. Such an arrangement facilitates loop-back data transmission to test the connections between a data input source and the interface 100.

A write data bus 290 carries data received from a RAM controller such as RAM controller 111 to data transmission components of the hard disk controller depicted in FIG. 5 in accordance with control signals transmitted on lines 291. The control lines 291 are connected to an input/output signal interface of the central controller 266. With regard to inbound data (to the hard disk), the write data bus 290 transmits data previously buffered in the RAM controller (e.g., RAM controller 111) for storage upon the hard disk. A first set of lines of the write data bus 290 are connected to the multiplexer 254 for purposes of transmitting buffered data from the RAM controller to the associated hard disk. With regard to outbound data from the hard disks, the write data bus 290 is connected to an input of the transmit data multiplexer 274. Thus, data retrieved from a connected hard disk and temporarily buffered in a burst data RAM (e.g., 110 or 112), is retrieved from the burst data RAM and transmitted via the data output FIFO buffer and message RAM 278 on lines 280 to the cell transmitter 118.

A second data path for outbound data from the hard disk is supplied by a direct sector data bus 293. The direct sector data bus 293 is connected to transmit data multiplexer 274 to optionally provide data directly to the transmit data multiplexer 274 from the hard disk rather than indirectly via the RAM 110 and RAM controller 111. However, in most cases data from the hard disk transmitted on data bus 293 is routed to the dynamic RAM multiplexer 270. The RAM multiplexer 270 transmits the received data to the dynamic RAM (e.g., RAM 110) via data bus 272.

The data transmitted on data bus 293 is also received by a CRC generator 296. As ATA DMA data is transmitted from the hard drive to data register 300 and then data bus 293, the CRC generator 296 builds a CRC check word that is sent to a CRC compare circuit 292 via CRC data bus 298. The data bus 293 is also coupled to the CRC compare circuit 292. The CRC compare circuit 292 captures a CRC word transmitted from an ATA hard drive at the conclusion of a data transfer (on data bus 293) and performs a CRC check operation. During the CRC check operation, the CRC compare circuit 292 compares the generated CRC word from CRC generator 296 to the expected CRC word issued by the ATA hard drive, and the CRC compare circuit 292 issues an appropriate value on line 294 to the central controller 266 to indicate the result of the compare.

A status data bus 302 is the fourth input into the transmit data multiplexer 274. The status bus 302 carries completion status as well as error conditions that arise during retrieval of data from the hard disk. These bits are collected from the PIO and DMA state machines and the various FIFOs that buffer data and/or commands, as well as the hard disk itself. These status and error bits relay the execution results of these logical blocks and indicate if there was a detected fault in any of the functions executed by those structures.

The central controller 266 comprises, by way of example, a hardwired circuit for controlling the operation of the hard disk controller components. In addition to the aforementioned input signals from the command decoder 262 and CRC compare circuit 292, the central controller 266 transmits and receives control and status signals via lines 304 connected to a transmit control circuit 306. The transmit control circuit 306 issues write and address control signals to the data output FIFO buffer and message RAM 278. A PIO state machine 310 and DMA state machine 312 are coupled via lines 314 to the central controller 266. The PIO state machine 310 and DMA state machine 312 provide control signals to the central controller 266 and a connected hard disk drive (via lines 316) based upon status signals supplied by the hard disk drive and/or the central controller 266.

The actual data from the hard disk drive (e.g., 102) is initially received via driver interface 256 and passed via data bus 320 to an input data multiplexer 322 arranged to receive data in a variety of forms. During PIO reads, data passes directly via data bus 320 to the multiplexer 322. However, during DMA reads the data is stored in positive edge triggered register 324 and negative edge triggered register 326. The registered positive and negative edge triggered data is transmitted via lines 330 and 332 to the multiplexer 322. During such DMA reads, the amount of data retrieved is controlled by a value stored within a DMA burst counter 334 that is controlled by a control signal on line 336 from the DMA state machine 312. The counter is cleared at the beginning of a DMA operation, incremented each time a positive edge triggered data register 324 is loaded with DMA data, and incremented each time a negative edge triggered data register 326 is loaded with DMA data. The DMA burst counter 334 transmits its current data count to the controller via line 335. In this way, the DMA state machine 312 can determine how much data the disk drive has sent and when to terminate the DMA transfer.

An exemplary controller, transmitter, and receiver have been schematically depicted in FIGS. 3-5. It is well within the scope of the capabilities of those skilled in the art to make modifications to the described disk controller, transmitter, and receiver, and their associated component circuitry that enable practice of the present invention - though in a different form. A primary goal of the disclosed disk controller circuit, cell transmitter, and cell receiver design is to perform the necessary and desired functions to transmit data to, and receive data from the cell transmitter 118 and cell receiver 130 without the need to pass data streams through an expensive and potentially bottleneck-inducing programmed central processor unit.

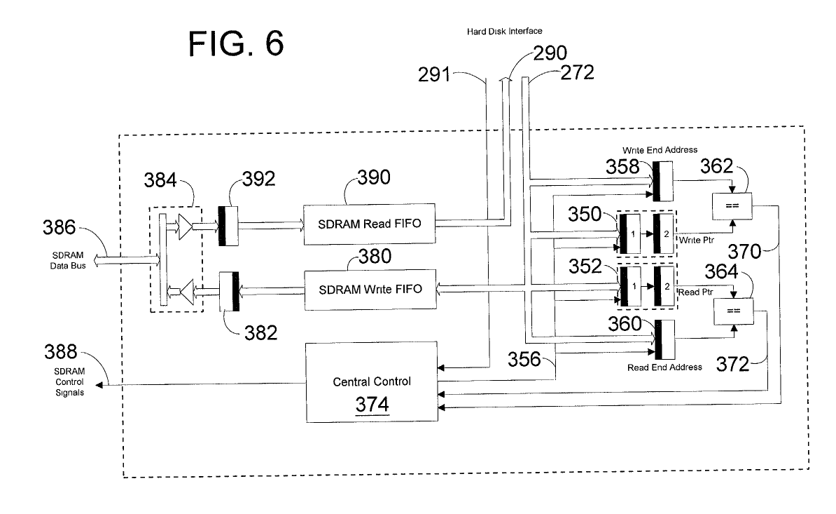

Having described the circuits and operation of a disk controller attention is now directed to FIG. 6 which describes the ram controller circuit (e.g., controller 111) of the exemplary interface 100. Write and read initial RAM address locations are transmitted on data bus 272 and received by a write level double buffer 350 and a read level double buffer 352 respectively. The addresses are loaded into the first register of the register pairs. Associated control signals are transmitted via line 356 to the write level double buffer 350 and read level double buffer 352 to enable loading of the initial addresses and to load and increment the associated secondary registers that act as address pointers. Write and read ending RAM address locations are transmitted on data bus 272 and received by a write end address register 358 and a read end address register 360 respectively. Associated control signals are transmitted via line 356 to the write end address register 358 and the read end address register 360 to enable loading of the ending addresses.

The contents of the secondary registers of the double buffers 350 and 352 are compared by comparators 362 and 364 to respective write and read end address registers 358 and 360. The write address comparison is done to determine when the writing of the RAM has completed so the reading of the RAM can proceed. The read address comparison determines when the data packet has been completely sent. If there is a condition detected in which the RAM buffer must be utilized in a “re-try” mode, then the first registers of the initial read address double buffer 352 and the initial write address double buffer 350 can be re-loaded into the secondary registers to again initialize the read and write address pointers. The results of the comparison are transmitted on line 370 for writes and line 372 for reads to a RAM controller central control 374.

Received data is initially stored in an SDRAM Write FIFO 380. The data is then stored in a register 382 prior to actually writing the data via a bi-directional driver interface 384. The transmission of data on driver data bus 386 is controlled by control signals transmitted on line 388 from the central control 374. Similarly, an SDRAM Read FIFO 390 receives data from a register 392 that receives data from the driver interface 384 under the control of signals transmitted by the central control 374 on line 388.

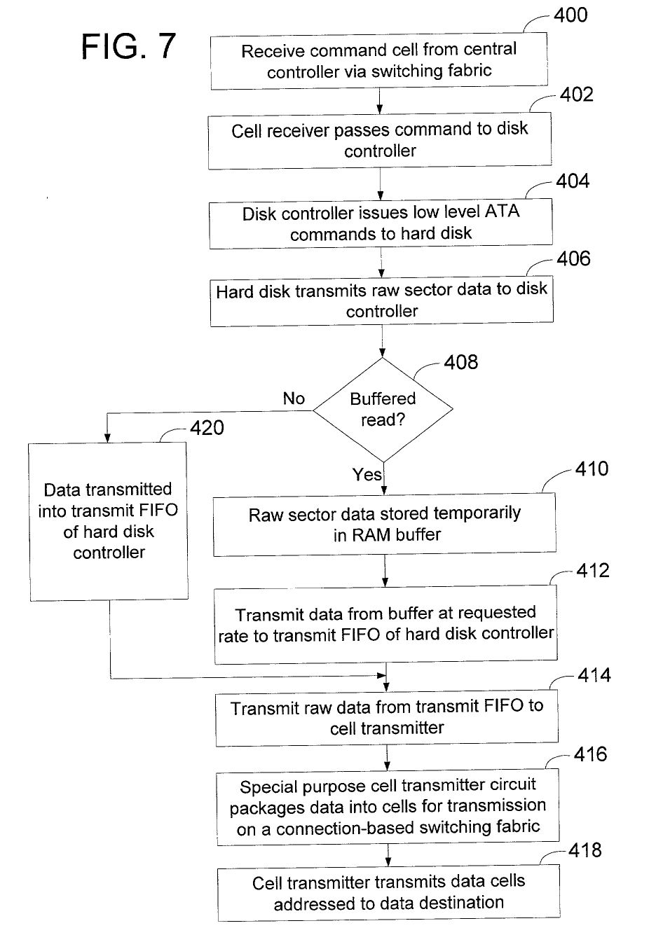

Having completed a description of an exemplary set of hardware circuits for implementing the interface 100 in accordance with an exemplary embodiment of the present invention, attention is now directed to FIG. 7 and a set of steps summarizing the flow of operations for retrieving data from a hard disk drive, converting the data to a set of cells, and transmitting a set of data cells over a connection-based fabric switch. During step 400, the cell receiver 130 receives a command cell from the switching fabric. The received cell contains a set of standard request parameters appropriate for identifying information assets to be retrieved and transmitted from a non-volatile memory. In the present exemplary embodiment the non-volatile memory comprises a hard disk and the exemplary request is submitted in accordance with ATA/IDE command protocols. The cell receiver 130 accepts the command cell and verifies the address, HEC, and CRC-32 values.

Next, during step 402 the cell receiver 130 sends the hard disk read command to the hard disk controller (e.g., hard disk controller 120). Thereafter, during step 404 the hard disk controller decodes the command and issues low level ATA commands to a hard disk (e.g., hard disk 102) containing requested information assets. More particularly, during step 404 the hard disk controller decodes a command cell received from the cell receiver 130 to determine the requested action. In the present example the action is a “read” request. The hard disk controller delivers an ATA sector read command to the hard disk using the PIO state machine 310 to guide completion of the read request based upon the parameters contained within the command cell.

During step 406 the hard disk responds to the sector read command with known hardware handshaking signals to facilitate a synchronous transmission of raw sector data back to the hard disk controller. The hard disk then commences transmitting the requested sectors. The DMA state machine 312 controls raw sector data transmission. The path taken by the raw sector data through the interface 100 depends upon whether a buffered or non-buffered read is being performed.

The interface 100 of the present invention supports both buffered and non-buffered reads from a hard disk. A buffered read introduces an initial delay while a pipeline of data is filled. However, the buffered read has the advantage over non-buffered reads of compensating for the bursty nature of hard disk reads—an initial delay while the disk head seeks the proper portion of a memory media followed by a very high speed data transfer. If a buffered read is to be performed, then control passes from step 408 to step 410. During step 410 the disk controller temporarily stores the retrieved raw sector data within a buffer RAM to facilitate a more smooth transmission of data via the interface 100. The disk controller passes the raw sector data to the RAM controller (e.g., RAM controller 111) to be stored within an associated buffer RAM (e.g., RAM 110). Due to the high speed nature of the transmission path from the disk controller to the buffer RAM, data is buffered as quickly as the hard disk can transmit the data. A set of parameters are transmitted by the disk controller (via the output FIFO and message RAM 278) to the cell transmitter 118. The cell transmitter uses the set of parameters to transmit the retrieved sector data over the switching fabric. Thereafter, the cell transmitter issues a pre-ack cell indicating the start of data cell transmission.

During step 412 the buffered raw sector data is retrieved from the buffer RAM by the RAM controller. The RAM controller passes the buffered data to the data out FIFO 278. The FIFO 278 then transmits the raw sector data to the cell transmitter (e.g., cell transmitter 118) during step 414. The cell transmitter includes special purpose circuitry for performing, during step 416, the task of packaging the received raw sector data into data cells having suitable headers for transmission on a connection-based switching fabric (e.g., an ATM switching fabric). A header added by the cell transmitter specifies the connection. The connection determines the route taken by the data cells through the switching fabric to a destination at the receiving side of the switching fabric. During step 418, the cell transmitter forwards data cells to the destination via the switching fabric. The final data cell includes a modified header identifying the cell as a final celI. The final cell also includes a CRC-32 word facilitating error detection with regard to the data within the transmitted cell sequence. The cell transmitter 118 issues a Post-ack cell after the final data cell of the transmitted cell sequence. The Post-ack cell indicates the end of a data cell sequence transaction and also provides a status indication with regard to the success or failure of the data transfer.

On the other hand, if at step 408 a non-buffered read is to be performed by the interface 100, then control passes to step 420. During step 420 the disk controller performs non-buffered retrieved raw sector data transmissions to the data out FIFO 278 (i.e., without first storing the data within a buffer RAM). Since this procedure avoids the additional overhead associated with data buffering, it will likely be preferable to the buffered transmission in instances where only a short message is being transmitted. Before transmitting retrieved data, during step 420, a set of parameters are transmitted by the disk controller (via the output FIFO and message RAM 278) to the cell transmitter 118. The parameters include destination path, payload byte count, and ack path. The cell transmitter 118 uses the set of parameters to transmit the retrieved sector data over the switching fabric.

Continuing with the description of step 420, the cell transmitter issues a pre-ack cell indicating the start of data cell transmission. Retrieved raw sector data within the hard disk controller passes directly from the retrieved data register 300 to the data out FIFO 278 via data bus 293 and multiplexer 274. Thereafter, during step 414, the FIFO 278 transmits the raw sector data to the cell transmitter 118. The remaining steps for packaging and transmitting raw data retrieved from the hard disk are described above and are therefore not repeated.

It is noted that even though the steps 406 through 418 and 420 are depicted as a set of sequential steps, those skilled in the art will appreciate that the disclosed embodiment of the present invention supports a pipelined process. Therefore, the sequence of steps is intended to represent the general flow of operations within a pipelined process rather than the actual sequence of steps performed by a system to transmit an information asset comprising many cells. Furthermore, the sequence of steps is merely exemplary, as are the particular manner in which they are carried out. Thus, the present invention contemplates modifications to both the ordering and content of specific steps performed to carry out the present invention.

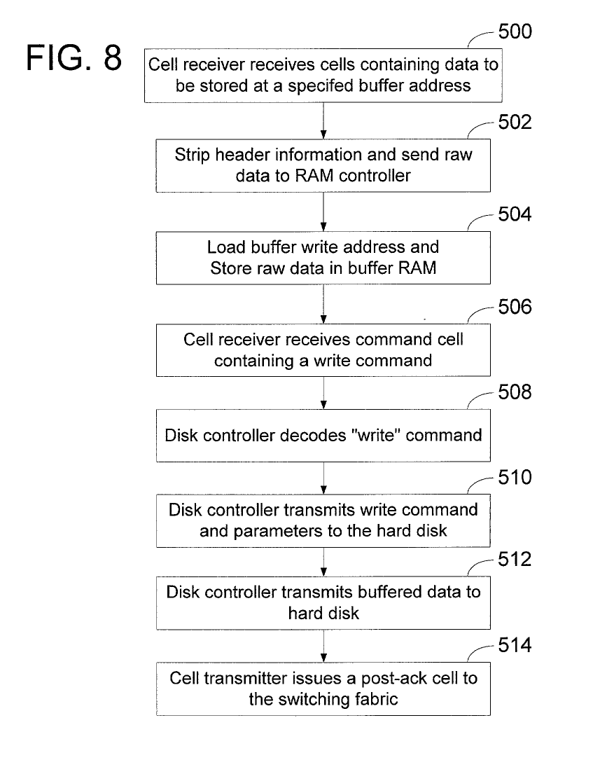

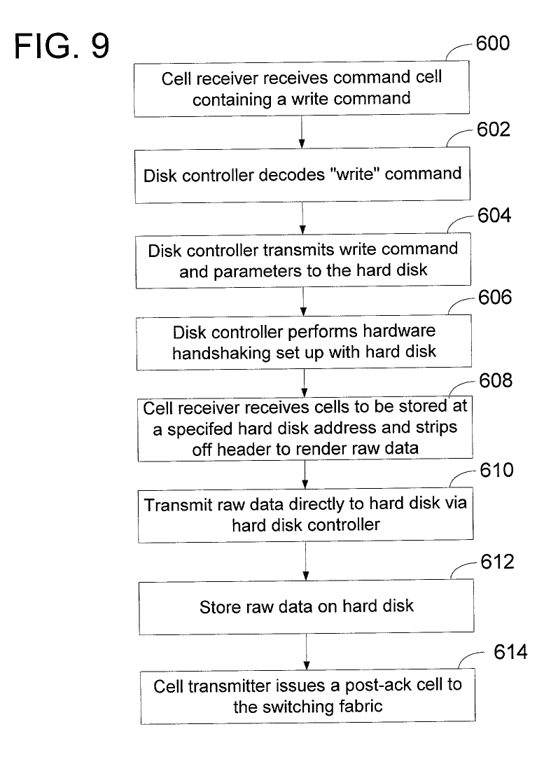

Having described an exemplary set of steps for carrying out buffered and non-buffered data reads from a non-volatile memory, attention is now directed to FIGS. 8 and 9 which summarize steps for performing buffered and non-buffered write operations utilizing the exemplary interface 100 embodying the present invention. Turning first to FIG. 8, a buffered write sequence commences at step 500 when the cell receiver 130 receives a sequence of data cells containing data to be stored at a specified address in the buffer. The cell receiver 130 verifies the address, HEC, and CRC-32 information. Upon verifying their accuracy, during step 502 the cell receiver 130 strips the header information from the data cells to render raw data. The raw data is passed to the hard disk controller (e.g., hard disk controller 120).

Furthermore, during step 502 the hard disk controller transmits a buffer write address and the raw data via data bus 272 to a buffer RAM controller (e.g., RAM controller 111). During step 504 the buffer RAM controller loads the buffer write address and stores the received raw data in a buffer RAM (e.g., RAM 110). Steps 500, 502 and 504 described above for receiving and storing data cells are performed in a pipelined manner. Thus, in the preferred embodiment, the cell receiver 130 receives and forwards data cells in accordance with step 500 while the disk controller and RAM controller are simultaneously stripping the header information and storing the received data in the buffer RAM. This pipelined process continues until the last data cell has been received and processed for a particular logical grouping (e.g., a packet) of data divided into a plurality of cells.

During steps 500 through 504 the interface 100 receives only a buffer address and data cells. The interface 100 has not received any directions with regard to handling the buffered data cells. However, at step 506 the cell receiver 130 receives a command cell from the switching fabric containing a write command. The cell receiver 130 verifies the address, HEC, and CRC-32 information within the command cell. Upon verifying its accuracy, the cell receiver 130 passes the command cell to the hard disk controller.

Next, during step 508, the command decoder 262 within the hard disk controller decodes the message type embedded within the received command cell. In the particular case of interest a write command is identified by the command decoder 262. Thereafter, during step 510 the hard disk controller transmits an ATA sector write command to the hard disk (e.g., 102). The PIO state machine 310, under direction of the central controller 266, issues a sector write ATA/IDE command to the hard disk via data bus interface 256 and disk control lines 316. The hard disk receives parameters associated with the write command via the data bus interface 256 and disk control lines 316.

During step 512 the hard disk controller performs known handshaking sequences with the hard disk and then delivers a set of requested sectors to the hard disk. In particular, the hard disk controller utilizes the DMA state machine 312 to control issuing read instruction sequences to the RAM controller to retrieve the previously buffered raw sector data from the buffer RAM. The DMA state machine 312 also controls issuing write instruction sequences facilitating transmitting the retrieved raw sector data to the hard disk via write data bus 290. The high speed data bus connections between the hard disk controller, RAM controller, and buffer RAM enable data transfers to the hard disk to occur at a rate limited only by the rate at which the hard disk can receive the raw sector data from the hard disk controller via write data bus 290.

During step 514, the cell transmitter 118, upon completing the write sequence to the hard disk, receives a set of parameters from the hard disk controller via the output FIFO and message RAM 278. The cell transmitter 118 issues a post-ack cell over the switching fabric. The post-ack cell indicates the end of the write sequence and a success or failure status for the data write operation.

Having described the steps associated with a buffered write process, attention is now directed to FIG. 9. This flowchart summarizes the steps for performing a non-buffered write to a hard disk from the switching fabric via the interface 100. In addition to not buffering received write data, the non-buffered write sequence primarily differs from the buffered write sequence with regard to the order of receiving the command and receiving the associated write data. In the case of a non-buffered write, the interface 100 receives the command cell first. The command cell is followed by a plurality of data cells containing raw write data.

A non-buffered write sequence commences at step 600 when the cell receiver 130 receives a command cell from the switching fabric. The command cell includes a write command and associated write parameters including data length and destination address on the hard disk. The cell receiver 130 verifies the address, HEC, and CRC-32 information within the command cell. Upon verifying its accuracy, the cell receiver 130 passes the command cell to the hard disk controller.

Next, during step 602, the command decoder 262 within the hard disk controller decodes the message type embedded within the received command cell. In the particular case of interest a write command is identified by the command decoder 262. Thereafter, during step 604 the hard disk controller transmits an ATA sector write command to the hard disk (e.g., 102). The PIO state machine 310, under direction of the central controller 266, issues a sector write command to the hard disk via the data bus interface 256 and disk control lines 316. The hard disk receives parameters associated with the write command via the data bus interface 256 and disk control lines 316.

During step 606 the hard disk controller performs known handshaking sequences with the hard disk. The hard disk then awaits delivery of data sectors. The DMA state machine 312 controls operation of the hard disk controller during actual data transfer to the hard disk. During step 608 the cell receiver 130 receives a sequence of data cells containing data to be stored at a specified location on the hard disk. The cell receiver 130 verifies the address, HEC, and CRC-32 information. Upon verifying their accuracy, the cell receiver 130 strips the header information from the data cells to render raw data and passes the data cells to the hard disk controller (e.g., hard disk controller 120) to be stored at the specified address.

During step 610 the hard disk controller, under sequence control by the DMA state machine 312, directly transmits the resulting raw data via data bus 252 to the hard disk without buffering the data first in the buffer RAM.

During step 612, the cell receiver and hard disk controller transfer data to the hard disk as fast as the hard disk can accept the data. Finally, during step 614, the cell transmitter 118, upon completing the write sequence to the hard disk, receives a set of parameters from the hard disk controller via the output FIFO and message RAM 278. The cell transmitter 118 issues a post-ack cell over the switching fabric. The post-ack cell indicates the end of the write sequence and a success or failure status for the data write operation.

Illustrative embodiments of the present invention and certain variations thereof have been provided in the Figures and accompanying written description. The present invention is not intended to be limited to these embodiments. Rather the present invention is intended to cover the disclosed embodiments as well as others falling within the scope and spirit of the invention to the fullest extent permitted in view of this disclosure and the inventions defined by the claims appended herein below.

[image]

[image]

[image]

[image]

[image]

[image]

[image]

[image]

[image]

[image]

[image]

[image]

[image]

[image]

[image]

[image]

[image]

[image]

[image]

What is claimed is:

1. A non-volatile data storage interface unit, for use in an information distribution system configured to distribute information assets stored upon a non-volatile data storage to users via a dynamic data transmission path including a cell-based switching fabric, the interface unit comprising:
a cell transceiver connectable to a cell-based switching fabric facilitating transfer of data cells between the non-volatile data storage interface unit and the cell-based switching fabric, the cell transceiver comprising:
a cell transmitter coupled to an output of the non-volatile data storage interface unit and comprising a raw data to cell data formatting circuit, and
a cell receiver coupled to an input of the non-volatile data storage interface unit and comprising a cell data to raw data formatting circuit; and
a first non-volatile data storage controller interposed between the cell transceiver and the non-volatile data storage, the non-volatile data storage controller comprising circuitry for:
retrieving and forwarding raw data from the non-volatile data storage to the cell transmitter, and
receiving and storing raw data from the cell receiver to the non-volatile data storage.

2. The non-volatile data storage interface unit of claim 1 further comprising a data buffer controller coupled to the first non-volatile data storage controller, the data buffer controller comprising an interface to random access memory for storing at least raw data retrieved from the non-volatile data storage by the first non-volatile data storage controller prior to transfer to the cell transmitter, thereby providing a data transmission rate smoothing interface between the non-volatile data storage and the cell transmitter.

3. The non-volatile data storage interface unit of claim 2 wherein the data buffer controller further comprises an interface to random access memory for storing raw data to be stored on the non-volatile data storage.

4. The non-volatile data storage interface unit of claim 1 wherein the cell-based switching fabric is an ATM switching fabric.

5. The non-volatile data storage interface unit of claim 1 wherein the cell-based switching fabric is a connection-oriented fabric.

6. The non-volatile data storage interface unit of claim 1 wherein the cell transmitter is coupled to a plurality of non-volatile data storage controllers, including the first non-volatile data storage controller.

7. The non-volatile data storage interface unit of claim 1 wherein the cell transmitter comprises circuitry for generating a header for a cell comprising raw data retrieved from the non-volatile data storage.

8. The non-volatile data storage interface unit of claim 7 wherein the circuitry for generating a header includes a CRC generator.

9. The non-volatile data storage interface unit of claim 8 wherein the circuitry for generating a header includes an HEC generator.

10. The non-volatile data storage interface unit of claim 1 wherein the cell receiver comprises circuitry for processing a header for a cell received from the cell-based switching fabric.

11. The non-volatile data storage interface unit of claim 10 wherein the circuitry for processing a header includes a CRC accumulator.

12. The non-volatile data storage interface unit of claim 11 wherein the circuitry for processing a header includes an HEC accumulator.

13. A method for transmitting data within an information distribution system configured to distribute information assets stored upon a non-volatile data storage to users via a dynamic data transmission path including a cell-based switching fabric, the method comprising, in any order, the steps of:
receiving, by a cell receiver, a data storage asset read command from the cell-based switching fabric;
passing, by the cell receiver to a non-volatile data storage controller, the data storage asset read command;
retrieving, from a non-volatile data storage controlled by the non-volatile data storage controller, raw data corresponding to the data storage asset read command;
first transmitting the raw data to a cell transmitter circuit;
packaging, by the cell transmitter circuit, the raw data within cells for transmission on the cell-based switching fabric; and
second transmitting, by the cell transmitter circuit, the cells to the cell-based switching fabric.

14. The method of claim 13 further comprising the step of:
storing, within a memory buffer prior to the first transmitting step, at least the raw data retrieved from the non-volatile data storage by the non-volatile data storage controller prior to transfer to the cell transmitter, thereby providing a data transmission rate smoothing interface between the non-volatile data storage and the cell transmitter.

15. The method of claim 13 wherein the second transmitting step comprises transmitting the cells to an ATM switching fabric.

16. The method of claim 13 wherein the cell-based switching fabric is a connection-oriented fabric.

17. The method of claim 13 wherein the packaging step comprises generating, by circuitry within the cell transmitter circuit, a header for a cell comprising raw data retrieved from the non-volatile data storage.

18. The method of claim 17 wherein the generating a header step includes generating a CRC value for a cell.

19. The method of claim 18 wherein the generating a header step includes generating an HEC value for a cell.

20. A method for receiving data within an information distribution system configured to communicate information assets from a non-volatile data storage to users via a dynamic data transmission path including a cell-based switching fabric, the method comprising, in any order, the steps of:
receiving, by a cell receiver connected to the cell-based switching fabric, a data storage asset write command from the cell-based switching fabric;
passing, by the cell receiver to a non-volatile data storage controller connected to the cell receiver, the data storage asset write command;
receiving, by the cell receiver, data cells specifying a hard disk address and raw data;
extracting, by the cell receiver, the raw data from the data cells;
transmitting, by the cell receiver, the raw data to the non-volatile data storage controller; and
storing, by the non-volatile data storage controller connected to the non-volatile data storage, the raw data to the non-volatile data storage.

21. The method of claim 20 further comprising the step of:
first processing, by the cell receiver, a header for a cell received from the cell-based switching fabric.

22. The method of claim 21 wherein the first processing step comprises processing header data by a CRC accumulator.

23. The method of claim 22 wherein the first processing step comprises processing header data by an HEC accumulator.

24. The method of claim 20 further comprising the step of:
buffering, by the non-volatile data storage controller, the raw data from the data cells prior to the storing step.
